(19) United States
(12) Patent Application Publication
(10) Pub. No.: US 2009/0230256 A1
(43) Pub. Date: Sep. 17, 2009

(54) Adapter for stacking cable hangers

(76) Inventors: Felix G. Widlacki, Orland Park, IL (US); William N. Anderson, Oak Forest, IL (US); Frederick W. Schmidt, Frankfort, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 12/075,547

(22) Filed: Mar. 12, 2008

(51) Int. Cl. F16L 3/22

(52) U.S. Cl. 248/68.1

(57) ABSTRACT

An adapter for use with a cable hanger which includes a U-shaped member having a center portion with legs securing a cable and securable to a structure. The adapter includes (1) a center platform defining an opening therein adapted to receive the legs of another cable hanger, (2) a pair of clamping members on opposite ends of the platform with feet spaced from the center platform and directed toward each other, and (3) legs on opposite sides of the platform and adapted to engage the cable hanger whereby the feet are held against the cable hanger center portion when mounted thereon. The clamping member feet are spaced apart less than the length of a cable hanger center portion, and the clamping members are elastically flexible to allow the feet to be separated sufficiently to clear opposite ends of a cable hanger center portion when mounting on the cable hanger.

### CROSS REFERENCE TO RELATED APPLICATION(S)

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

1. Technical Field

The present invention is directed toward cable hangers for securing long members such as cables to a structure, and particularly toward stackable cable hangers.

2, Technical Problems Posed by the Prior Art

Cable hangers have long been used to secure cables to a structure such as a radio tower, where the cable hangers are brackets which secure around a portion of the cable and also secure to the tower, such as a tower leg. Multiple ones of such cable hangers are typically used to secure the length of a cable to a structure.

For example, multiple cable hangers such as shown in U.S. Pat. No. 5,967,468 have been used to attach a single cable to a tower. U.S. Pat. No. 4,763,132 similarly illustrates a waveguide hanger for attaching a single waveguide to a tower. (As used herein, references to cable are meant to incorporate not only cables but also other longitudinal members such as waveguides, having a variety of cross-sectional shapes.) When it is desired to attach more than one cable to a tower, however, this can present a problem. Particularly when a second or subsequent cable is added later, it may be difficult to attach new cable hangers to a tower since they will be blocked by the previously mounted cable hangers and supported cable. Moreover, given that such towers can extend hundreds of feet into the air, such bothersome cable attachment can be particularly frustrating and dangerous for the person whose job it is to attach the new cable.

Stackable hangers have also been developed, such as shown in U.S. Pat. Nos. 6,899,305 and 7,097,142, the full disclosures of which are hereby incorporated by reference. These hangers can be attached to each other to allow more than one cable to be attached to the tower where the second cable can be readily attached without concern for the fact that the first cable and its hangers may block access to attaching directly to the tower. However, stackable hangers do not necessarily provide the same mounting strength as non-stackable hangers. For example, a stackable hanger mounted on a stackable hanger may not secure its cable as well as a non-stackable hanger secures a cable directly to the tower.

Also, the cost of stackable hangers can be higher than non-stackable hangers such as described above. As a result, when constructing a tower where only a single cable is to be attached to a tower leg, it can be unnecessarily costly to use stackable hangers (since no stacking is required). On the other hand, if non-stackable hangers are used though only a single cable is intended to be hung (e.g., to save money during initial construction or, in the case of many older towers, as a result of the unavailability of stackable hangers when the tower was originally constructed), changing the tower to later add more cables can be extremely difficult and costly to do so. That is, retrofitting a tower with additional cables may necessitate attaching the new cables in a less than ideal manner (i.e., in a manner which works around the previously mounted cable but then results in an attachment which is not as secure as desirable). Alternatively, the old non-stackable hangers may be removed and replaced with all new stackable hangers. However, such replacement may be extremely costly, difficult and dangerous. That is, replacing old non-stackable hangers (which may have hung on the tower for years) with new stackable hangers would require detaching the old hangers from the tower and cable, which would not only would risk damaging the old cable but also can be expected to be difficult, dangerous, and time consuming for a worker. Removal of the old hangers would require a worker to be suspended at varying and dangerous heights, where the worker would have to individually remove each old hanger, which over time may have become variously bent, rusted, corroded, etc. and therefore much more difficult to remove than when originally secured to the tower. Moreover, such retrofitting requires not only new hangers for the new cable(s) but also new replacement stackable hangers for the original cable so that, for example, adding one new cable would require sets of new cable hangers sufficient to hang two cables (the original cable and the new one).

Moreover, notwithstanding the prior stackable hangers such as mentioned herein, secure stacking of non-cylindrical longitudinal members such as waveguides has not heretofore been accomplished.

The present invention is directed toward overcoming one or more of the problems set forth above.

### SUMMARY OF THE INVENTION

In one aspect of the present invention, an adapter is provided for use with a cable hanger, wherein the hanger includes a generally U-shaped member having a center portion and legs with a cable engaging section in each leg adapted to secure a cable to the legs, and the hanger further being adapted to attach cables to a tower leg. The adapter includes (1) a center platform defining an opening therein adapted to receive the legs of another cable hanger for securing the another cable hanger to the platform, (2) a pair of clamping members on opposite ends of the center platform with feet spaced from the center platform and directed toward each other, and (3) legs on opposite sides of the center platform and adapted to engage the cable hanger whereby the clamping member feet are held against the cable hanger center portion when mounted to the cable hanger. The clamping member feet are spaced apart less than the length of a cable hanger center portion, and the clamping members are elastically flexible to allow the feet to be separated sufficiently to clear opposite ends of a cable hanger center portion when mounting on the cable hanger.

In one form of this aspect of the present invention, the feet are tapered toward the center platform whereby pushing the adapter onto a cable hanger creates a force biasing the clamping members apart.

In another form of this aspect of the present invention, the center platform includes a recessed area extending between the platform ends, and the platform opening is in the recessed area.

In still another form of this aspect of the present invention, the platform is flexible for elastic bending around an axis extending between its ends.

In another aspect of the present invention, a mount is provided for hanging first and second cables on a structure. The mount includes a first cable hanger, an adapter and a second cable hanger. The first cable hanger includes a generally U-shaped member having a center portion and legs with a cable engaging section in each leg adapted to secure a first cable to the legs. The hanger being adapted to attach the first cable to a structure. The adapter includes a center platform defining an opening therein, a pair of clamping members on opposite ends of the center platform with feet on the clamping members spaced from the center platform and directed toward each other, and legs on opposite sides of the center platform. The clamping member feet are spaced apart less than the length of the center portion of the first cable hanger, and the clamping members are elastically flexible to allow the feet to be separated sufficiently to clear opposite ends of a cable hanger center portion when mounting on the first cable hanger. The adapter legs engage the first cable hanger to substantially secure the clamping member feet against the cable hanger center portion. The second cable hanger has two legs with the second cable secured between the legs and is secured to the adapter center platform with the second cable hanger legs secured in the adapter center platform opening.

In one form of this aspect of the present invention, the feet are tapered toward the center platform whereby pushing the adapter onto a cable hanger creates a force biasing the clamping members apart.

In another form of this aspect of the present invention, the center platform includes a recessed area extending between the platform ends, and the platform opening is in the recessed area.

In still another form of this aspect of the present invention, the platform is flexible for elastic bending around an axis extending between its ends.

In yet another form of this aspect of the present invention, the first cable hanger has an opening therein aligned with the adapter center platform opening, and the second cable hanger legs extend into the first cable hanger opening.

In a still further form of this aspect of the present invention, the structure is a tower leg.

In a further form of this aspect of the present invention, the first and second cables are first and second waveguides having a generally elliptical cross section and the legs of the first and second cable hangers are adapted to engage the longer sides of the first and second waveguides.

### BRIEF DESCRIPTION OF THE DRAWINGS

FIG. 1 is a perspective view of two cable hangers stacked together using adapters according to the present invention, with two cables secured thereto;

FIG. 2 is a perspective exploded view showing assembly of a non-stackable cable hanger with an adapter according to the present invention;

FIGS. 3-5 sequentially illustrate from an end view the manner in which a cable hanger may be attached to an adapter and the manner in which another adapter may be attached to a cable hanger for further hanging;

FIG. 6 is an end view of FIG. 1; and

FIG. 7 is a cross-sectional view taken along line 7-7 of FIG. 6.

### DETAILED DESCRIPTION OF THE INVENTION

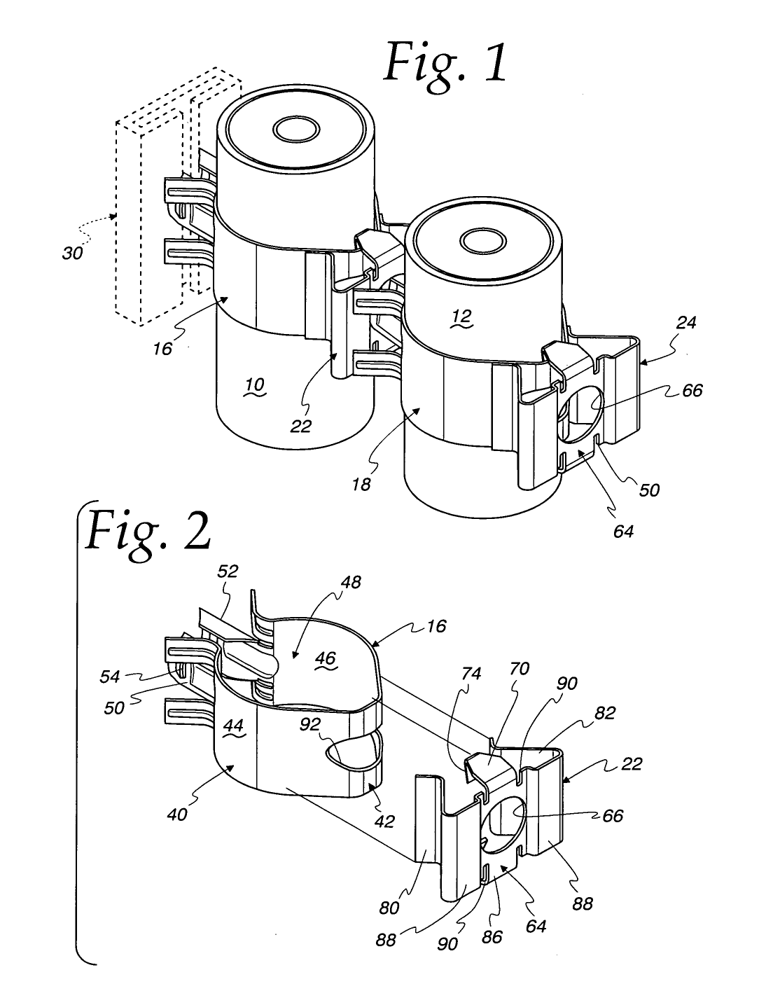

FIG. 1 illustrates a pair of cables 10, 12 stacked together using a pair of cable hangers 16, 18 and a pair of adapters 22, 24 according to the present invention.

(As previously noted, as used herein, references herein to cable are meant to incorporate not only cables in the conventional sense but also other longitudinal members, such as waveguides, which may have a variety of cross-sectional shapes including elliptical, square, rectangular and round.)

It should be appreciated that the cable hangers 16, 18 may be of a prior art non-stackable configuration. As illustrated in phantom, the bottom cable hanger 16 may be suitably secured to a structure 30 such as a tower leg as illustrated, for example, in U.S. Pat. No. 5,976,468, the full disclosure of which is hereby incorporated by reference. Further, when hanging cables such as waveguides, the hangers may be of a configuration such as illustrated in U.S. Pat. No. 4,763,132, which hangers may, for example, be secured to a tower leg such as illustrated in that patent. The full disclosure of U.S. Pat. No. 4,763,132 is also hereby incorporated by reference. Again, it should be appreciated that while the description herein is made to hanging conventional long cylindrical cables, the present invention may also be used to significant advantage when hanging non-cylindrical longitudinal members such as waveguides.

It should be appreciated that the structure illustrated in FIG. 1 could stack two cables 10, 12 without requiring the second adapter 24. As illustrated with the second adapter 24, a third cable hanger could be attached to the second hanger 18 and adapter 24 so that three cables could be mounted together.

The basic cable hanger 16 includes a generally U-shaped member 40 with a center portion 42 between a pair of legs 44, 46 defining a cable engaging section 48 and leg extensions 50, 52 which may be squeezed together to both squeeze the cable engaging section 48 around a cable 10, as well as to permit the leg extensions to be moved through a suitable opening in the structure 30. Locking members 54, 56 project outwardly from the leg extensions 50, 52 and snap out beneath the surface of the structure opening to retain the cable hanger in the opening. Supporting members 58, 60 are positioned to engage the outer surface of the structure 30 so that the leg extensions 50, 52 are biased slightly out of the structure opening to thereby pull the hanger 16 so that the locking members 54, 56 are held against inside surface of the structure opening whereby the cable hanger 16 is substantially fixed relative to the structure 30 without substantial wobble.

An advantageous adapter 22 according to the present invention is separately illustrated in the exploded view of FIG. 2. The adapter 22 includes a center platform 64 with an opening therein 66. A pair of clamping members 70, 72 are on opposite ends of the center platform 64, with the clamping members 70, 72 including feet 74, 76 spaced from the center platform 64 and directed toward each other.

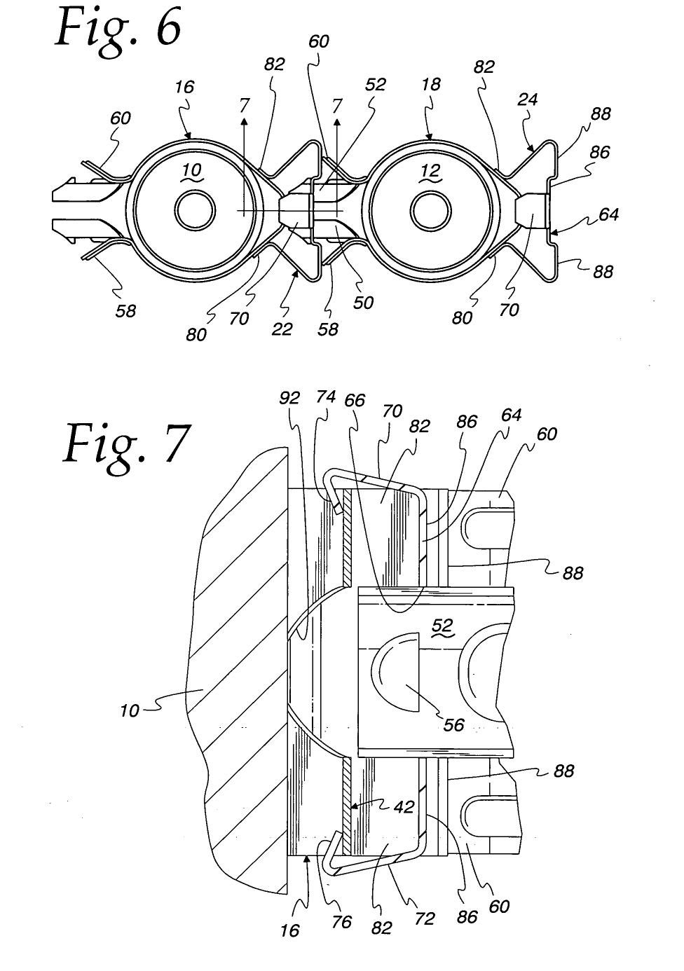

As best seen in FIG. 7, the feet 74, 76 feet are spaced apart less than the length of the center portion 42 of the cable hanger 16. Further, the feet 74, 76 are tapered toward the center platform 64, and the clamping members 70, 72 are sufficiently elastically flexible to allow the feet 74, 76 to be separated enough to clear the ends of the cable hanger center portion 42 (i.e., the top and bottom in the FIG. 7 view) during mounting on the cable hanger 16. For example, if pushed straight on such as shown in FIG. 2, the taper of the feet 74, 76 will cause them to separate as they slide onto the ends of the hanger center portion 42 until they are sufficiently separated that they will pass over the center portion 42. Once the feet 74, 76 pass over the center portion 42, the clamping members 70, 72 will snap back together on the back side of the hanger center portion 42 to hold the adapter 22 on the hanger 16 (again, see FIG. 7).

Alternatively, it should be appreciated that the adapter 22 could be mounted by first locating one of the feet 74 or 76 under one end of the hanger center portion 42 and then pushing the other end of the adapter 22 down until its foot 76 or 74 flexes out clear of the other end of the hanger center portion 42, at which point that adapter end will move onto the hanger center portion 42 until that foot 76 or 74 can snap onto the underside of the center portion 42. With this configuration, less flexing of the legs 70, 72 is required, enabling the adapter 22 to be more easily mounted onto the hanger 16 and/or for the clamping members 70, 72 to be formed more rigidly to improve strength without increasing the force required to mount the adapter 22 onto the hanger 16.

Legs 80, 82 on opposite sides of the center platform 64 will at the same time engage the cable hanger 16 on its outer face, with the combined spring action of the legs 80, 82 on the outside of the hanger 16 and the feet 74, 76 on the inside of the hanger 16 will rigidly secure the adapter 22 to the hanger 16 such as can be seen in FIGS. 1 and 5-7.

The center platform 64 of the adapter 22 may include a recessed area 86 between two raised areas 88 and extending between the ends of the center platform 64, with the opening 66 being in the recessed area 86. It should be appreciated that this configuration will provide a substantially advantageous rigid mounting platform for another hanger 18, while at the same time providing flexibility for elastic bending around an axis extending between the adapter ends such as taught in U.S. Pat. No. 7,097,142 and as also discussed below. Cuts 90 on either side of the clamping members 70, 72 may also be provided to facilitate such flexibility of the center platform 64 on either side of the substantially inflexible bend connecting the clamping members 70, 72 and the central section of the recessed area 86.

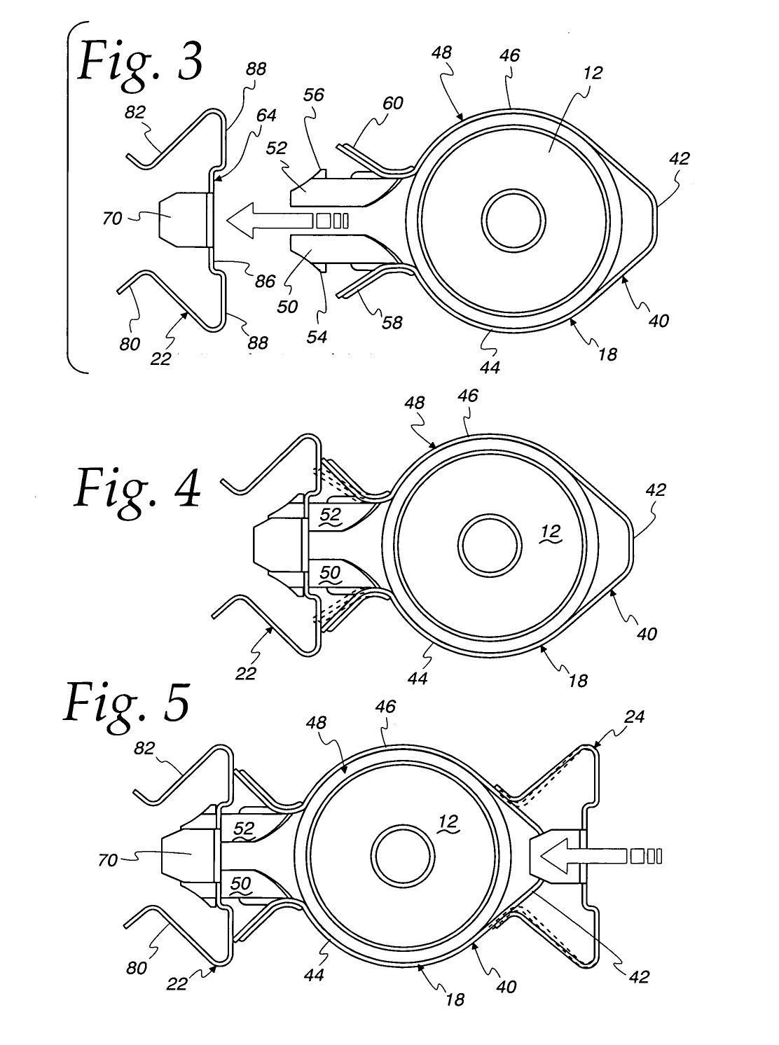

Specifically, it should be appreciated that a second cable hanger 18 can be stacked onto a non-stackable cable hanger 16 and adapter 22 in a manner similar to the way that cable hangers could be stacked onto stackable cable hangers such as U.S. Pat. No. 7,097,142. That is, the leg extensions 50, 52 of a hanger 18 can be squeezed together to pass through the opening 66 in the adapter center platform 64 and then released so that its locking members 54, 56 are retained on the back (underside) of the recessed area 86 (see FIGS. 3-4). The supporting members 58, 60 engage the front (outer side) of the raised areas 88.

Moreover, it should be appreciated that with the present invention, where the cable hanger 16 has an opening 92 in its center portion 42 as may be provided to both save materials and to provide the desired flexibility to the hanger 16, the mounting of a second cable hanger 18 can be stronger and more reliable than even one piece stackable hangers such as used in the prior art. That is, with such an opening aligned beneath the opening 66 of the adapter center platform 64. the leg extensions 50, 52 of the hanger 18 may extend not only through the adapter opening 66 but also through the hanger opening 92 as well, thereby providing two areas supporting the leg extensions 50, 52 at spaced apart locations to significantly enhance the rigidity of the mounting.

It should thus be appreciated that the present invention will allow stacking of hung cables even where non-stackable hangers have been used. Adapters incorporating the present invention will therefore allow advantageous stacking to occur on structures which have previously had one cable hung using non-stackable hangers without requiring that such hangers be removed and replaced, both of which are both costly and time consuming operations. Moreover, worker safety can be enhanced by requiring less work at dangerous heights on towers as well as making the work which is required simpler and more easily accomplished. Moreover, it should be appreciated that using adapters according to the present invention can provide improved hanging strength and reliability over hangers which have been intentionally designed for stacking.

It should further be appreciated that the present invention will advantageously allow waveguides to also be securely and reliably hung on a tower in a stacked configuration.

Still other aspects, objects, and advantages of the present invention can be obtained from a study of the specification, the drawings, and the appended claims. It should be understood, however, that the present invention could be used in alternate forms where less than all of the objects and advantages of the present invention and preferred embodiment as described above would be obtained.

1. An adapter for use with a cable hanger, wherein said hanger includes a generally U-shaped member having a center portion and legs with a cable engaging section in each leg adapted to secure a cable to said legs, said hanger being adapted to attach cables to a structure, said adapter comprising:
a center platform defining an opening therein adapted to receive the legs of another cable hanger for securing said another cable hanger to said platform;
a pair of clamping members on opposite ends of said center platform, said clamping members including feet spaced from said center platform and directed toward each other, whereby
said feet are spaced apart less than the length of a cable hanger center portion, and
said clamping members are elastically flexible to allow said feet to be separated sufficiently to clear opposite ends of a cable hanger center portion when mounting on the cable hanger; and
legs on opposite sides of said center platform and adapted to engage the cable hanger whereby said clamping member feet are held against the cable hanger center portion when mounted to the cable hanger.

2. The adapter of claim 1, wherein said feet are tapered toward said center platform whereby pushing said adapter onto a cable hanger creates a force biasing said clamping members apart.

3. The adapter of claim 1, wherein said center platform includes a recessed area extending between the platform ends, and said platform opening is in said recessed area.

4. The adapter of claim 1, wherein said platform is flexible for elastic bending around an axis extending between its ends.

5. A mount for hanging first and second cables on a structure comprising:
a first cable hanger including a generally U-shaped member having a center portion and legs with a cable engaging section in each leg adapted to secure a first cable to said legs, said hanger being adapted to attach said first cable to a structure; and
an adapter including
a center platform defining an opening therein,
a pair of clamping members on opposite ends of said center platform, said clamping members including feet spaced from said center platform and directed toward each other, whereby
said feet are spaced apart less than the length of the center portion of the first cable hanger, and
said clamping members are elastically flexible to allow said feet to be separated sufficiently to clear opposite ends of a cable hanger center portion when mounting on the first cable hanger, and
legs on opposite sides of said center platform and engaging the first cable hanger to substantially secure the clamping member feet against the cable hanger center portion; and
a second cable hanger having two legs with said second cable secured between said legs, said second cable hanger being secured to said adapter center platform with said second cable hanger legs secured in said adapter center platform opening.

6. The mount of claim 5, wherein said feet are tapered toward said center platform whereby pushing said adapter onto a cable hanger creates a force biasing said clamping members apart.

7. The mount of claim 5, wherein said center platform includes a recessed area extending between the platform ends, and said platform opening is in said recessed area.

8. The mount of claim 5, wherein said platform is flexible for elastic bending around an axis extending between its ends.

9. The mount of claim 5, wherein said first cable hanger has an opening therein aligned with said adapter center platform opening, and said second cable hanger legs extend into said first cable hanger opening.

10. The mount of claim 5, wherein the structure is a tower leg.

11. The mount of claim 5, wherein said first and second cables are first and second waveguides having a generally elliptical cross section and said legs of said first and second cable hangers are adapted to engage the longer sides of the first and second waveguides.
